(19) United States
(12) Patent Application Publication
(10) Pub. No.: US 2017/0060972 A1
(43) Pub. Date: Mar. 2, 2017

(54) SYSTEMS AND METHODS FOR PROCESSING PROCESS DATA

(71) Applicant: General Electric Company, Schenectady, NY (US)

(72) Inventors: Justin DeSpenza McHugh, Niskayuna, NY (US); Andrew Walter Crapo, Scotia, NY (US)

(21) Appl. No.: 14/839,434

(22) Filed: Aug. 28, 2015

(51) Int. Cl. G06F 17/30

(52) U.S. Cl. CPC G06F 17/30569; G06F 17/30604

(57) ABSTRACT

Disclosed are systems, methods, and machine-readable storage media for converting process data extracted from one or more data source systems into a data-source-independent intermediate representation, and then applying a domain-specific semantic ontology to the intermediate representation to create a semantic representation of the process data. The intermediate representation may specify, for each instances of a process object within a process flow, a unique identifier, a set of observations, and references to process-object instance immediately preceding or following the process-object instance at issue.

### TECHNICAL FIELD

The subject matter disclosed herein relates to the processing of data captured for industrial or other processes, as well as to semantic representations of such process data.

### BACKGROUND

Manufacturing and other process-oriented activities generate large amounts of data that contains value to the business for maintaining quality, making improvements, and reducing costs. This data tends to be stored in formats convenient to the storage strategy, rather than in formats that directly represent the process for which the data was captured. Additionally, the data is often split over multiple physical recording systems that may employ different storage strategies. For example, on a manufacturing floor, multiple machines carrying out different parts of an overall manufacturing process may each independently monitor and log their own activities and state. To allow effective use of such data, the data may, on a case-by-case basis as needed, be re-assembled manually, prior to consumption by an end-user, into a process-oriented format that captures the relationships between process steps, ordered in time as well as by dependency. In some circumstances, the value of the data can be further enhanced by attaching domain-specific terms and rules to the linked data.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system, in accordance with an example embodiment, for ingesting process data into a semantic store.

FIG. 2 is a diagram conceptually illustrating a process flow in accordance with an example embodiment.

FIG. 3 is block diagram conceptually illustrating the representation of an individual process-object instance in a data-source-independent intermediate format in accordance with an example embodiment.

FIG. 4A is a diagram illustrating process data for a portion of an example process and an associated process-object instance in the intermediate format, in accordance with an example embodiment.

FIG. 4B is a diagram illustrating an example semantic representation corresponding to the process-object instance of FIG. 4A, in accordance with an example embodiment.

FIG. 4C is a diagram illustrating an example semantic model expressed in semantic application design language (SADL), in accordance with an example embodiment.

FIG. 5 is a flow chart illustrating a method, in accordance with an example embodiment, for ingesting process data from one or more data source systems into a semantic store.

FIG. 6 is a block diagram of a machine in the example form of a computer system within which instructions may be executed to cause the machine to perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. For purposes of explanation, numerous specific details are set forth in order to provide an understanding of various embodiments of the inventive subject matter. It will be evident, however, to those skilled in the art that embodiments of the inventive subject matter may be practiced without these specific details. Further, well-known instruction instances, protocols, structures, and techniques are generally not shown in detail herein.

Disclosed herein are systems and methods for automatically converting data captured for time-ordered processes from one or more data sources where the data is stored in one or more storage-oriented formats that need not, and generally do not, reflect the semantics of the data, into a semantic, process-oriented format. A “time-ordered process,” or simply “process,” as used herein, generally denotes a collection of actions (hereinafter “process steps”) taken, and/or materials or resources used or produced by these actions (hereinafter collectively “materials”), that are at least partially ordered in time and/or by dependency. Non-limiting examples of processes are manufacturing processes, which generally involve manufacturing a certain product in a series of process steps from a number of materials or components, and business processes, such as payroll, invoice processing, supply chain management, etc. “Process data,” i.e., data captured for a process, generally includes—explicitly or implicitly—structural information about the temporal sequence and/or dependencies between the process steps and materials (hereinafter collectively “process objects”), as well as data (e.g., resulting from measurements or human input) associated with the individual instances of the process objects.

In various embodiments, the conversion of process data from a storage-oriented format into a semantic format is accomplished in two tiers: First, the process data is extracted from the source system(s) and converted into a data-source-independent intermediate data representation that specifies for each process-object instance a unique identifier, a set of observations (such as measurements or other data) associated with the process-object instance, and sets of other process-object instances that immediately precede or immediately follow the process-object instance in the process flow. Second, a domain-specific semantic ontology is applied to the intermediate representation to create a semantic representation of the process data. The intermediate representation is process-oriented inasmuch as it organizes the data (possibly after aggregation across multiple disparate sources) by process object and reflects dependencies between the process objects by virtue of the references to the preceding and following process objects. However, the intermediate representation is generally devoid of domain-specific meaning, i.e., while it captures the structural relations between process objects, it does not reveal the nature or content of the individual process objects themselves. In the semantic representation, domain-specific knowledge is added.

In some embodiments, the semantic representation of the process data is loaded into a semantic store, such as, e.g., a triplestore or quadstore (a triplestore with a graph identifier attached to each triple). Optionally, data may also be extracted into a relational-database cache or other cache. The semantic store (or, in some embodiments, relational database cache) may then be queried by an end-user to obtain meaningful, process-specific and domain-specific information—in other words, information geared toward human understandability and reporting. Beneficially, the end-user need not have knowledge of the particular data-source system, from which he is isolated through the automatic data-conversion process. Further features and benefits of the disclosed subject matter will become apparent from the following description of various example embodiments.

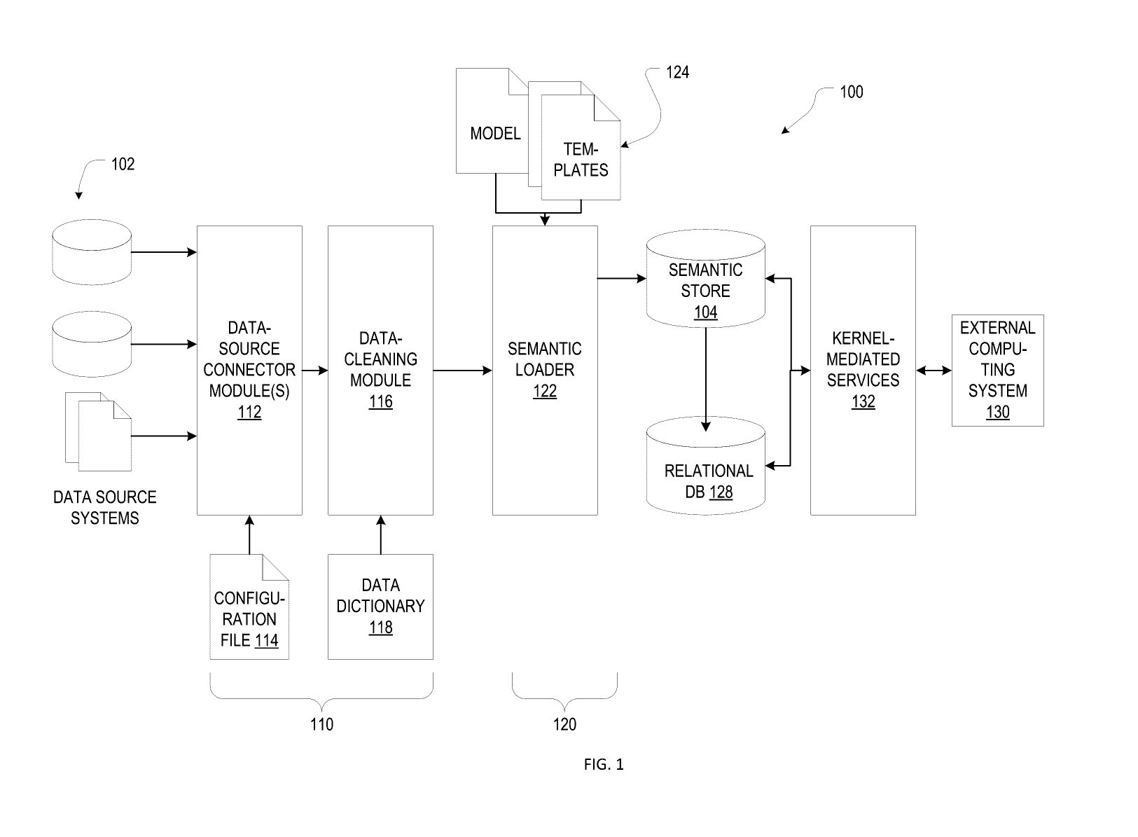

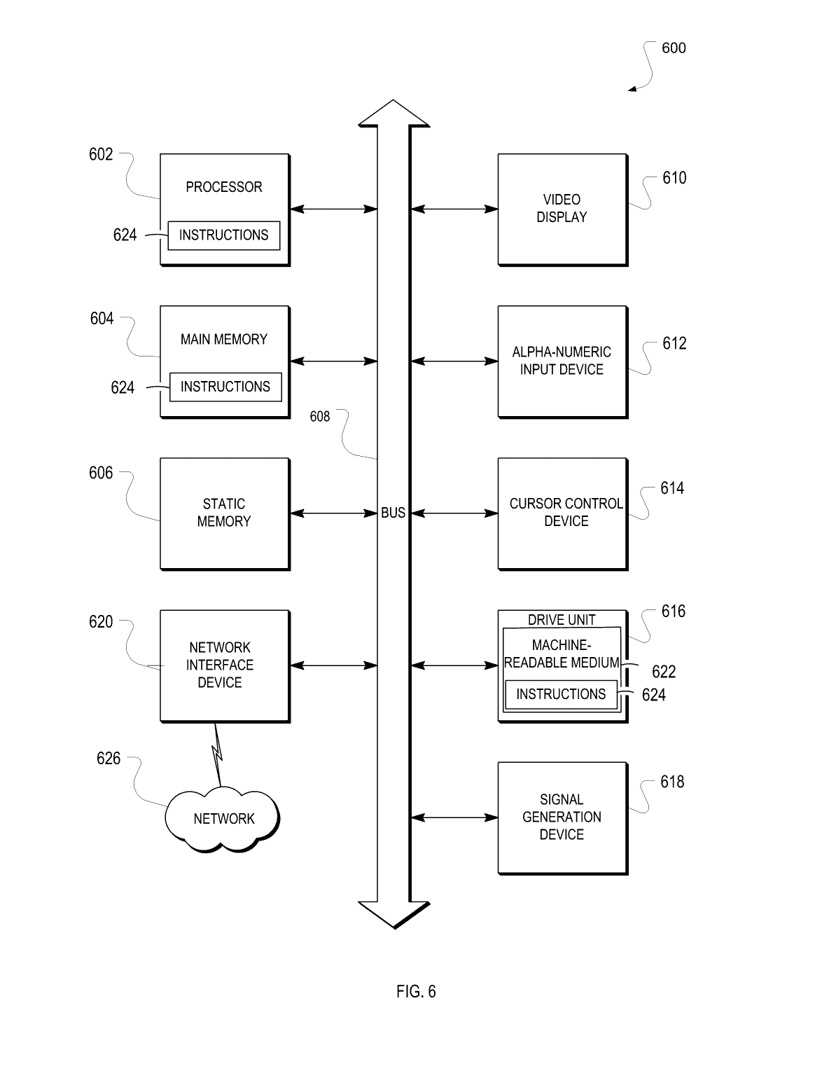

FIG. 1 is a block diagram illustrating a system 100, in accordance with an example embodiment, for ingesting process data extracted from one or more data source systems 102 into a semantic store 104. As shown, the data is processed via a pipeline of processing modules, which may be implemented in hardware, software, or a combination of both. The modules may be provided or (if implemented in software) executed by a single computing machine or by multiple communicatively coupled computing machines (such as, e.g., networked general-purpose computers running various software applications corresponding to the modules). Further detail regarding suitable machine and software architectures is provided below, e.g., with reference to FIG. 6.

In the first processing tier 110 of the pipeline, a data-source connector module 112 (or multiple such modules) extracts the process data from the data source system(s) 102 (e.g., the system where the data was originally recorded, such as the data store of a manufacturing system, or a replica of the original storage system), and converts the data into the intermediate format. Within the data source system(s) 102, the process data may be stored in various different ways, for instance, in one or more databases (relational or other), or in a collection of flat files supplemented by one or more flow charts containing structural information about the process. To provide a few concrete examples: the source data systems may utilize or include a graph database, hundreds of spreadsheets and flow charts, a specialized manufacturing plant application (as provided, e.g., by General Electric, headquartered in Fairfield, Connecticut), or a database such as Oracle™ including the structural information in conjunction with a data repository such as Historian™ (provided by General Electric).

Although the original representation of the process data provides, at least implicitly, information about the process flow, the data is generally not organized in data structures corresponding to instances of process objects. Rather, data pertaining to a single process-object instance may generally be stored in different records or even different storage systems. The data-source connector module 112 re-assembles and organizes the extracted data by process-object instance. In order to do so, the data-source connector module 112 is generally specifically adapted to the particular source system and storage strategy employed. The term “storage strategy” refers to the way in which the data is modeled in the storage system, such as whether it is stored in a database or a collection of flat files, or, in case of database storage, what type of database (relational, hierarchical, or other) and/or what schema is being used. Accordingly, to process data from different source systems, different data-source connector modules 112 are generally utilized. For example, there may be a connector module 112 for a particular plant application, another connector module 112 for systems using Oracle™ and Historian™, yet another connector module 112 for a particular graph database, etc. Further, to capture minor storage-format variations between different versions or different deployment instances of a given data source system 102, the connector module 112 may accept a configuration file 114 as input. Regardless of the data source system 102 utilized, the intermediate data representation output by the connector module 112 is generally the same for any given process instance, apart from labels (e.g., identifiers and descriptions) of the individual data structures and variables, and/or minor source-system idiosyncrasies. In this sense, the intermediate representation is data-source-independent.

In some example embodiments, as illustrated, the first processing tier 110 further includes a data-cleaning module 116 that prepares the intermediate format for subsequent application of a semantic model. The data-cleaning module 116 may map the data for the identified process-object instances against a data dictionary 118 to make sense of labeling conveniences employed in the data source systems 102, e.g., by recognizing different instances of the same logical process object, or different instances of the same variable (representing an observation) associated with a logical process object, as such, even if the labels in the source storage tier do not suggest any such correspondence between the process-object instances or variables. In other words, the data-cleaning module 116 may identify process objects of the same type and related variables. Note, however, that the type of process object does not carry any domain-specific meaning at this stage. For example, it may not be apparent from the intermediate data for, say, a manufacturing process what product is being manufactured, what physical manipulations are being performed to make the product, which parameters are being measured at various steps of the process, and so on.

The data dictionary 118 need not necessarily be complete, and some process-object instances of the intermediate format may therefore not map onto any of the entries within the data dictionary 118. In this event, the unidentifiable process-object instance(s) may be labeled as being of type “unknown.” Importantly, to ensure the integrity of the process-flow representation, the unknown process-object instances are in general not omitted from the data transferred to the second processing tier 120 for ingestion into the semantic store 104, but are included as placeholders. In fact, in some circumstances, the application of a semantic ontology to the data may provide sufficient context to ascertain previously unknown types of process-object instances and update the data dictionary 118 accordingly. As long as a process-object instance is unknown, there may, however, be no utility in further processing its associated data, in some embodiments. The data-cleaning module 116 may therefore implement functionality for filtering the data in the intermediate format to retain only data for observations associated with known process-object instances. Further, in some embodiments, the data source system 102 may store mock-data for debugging and testing purposes; since such data is not related to the actual process being monitored, it may be eliminated prior to data transfer to the second processing tier 120. Other types of black-listing or white-listing data may occur to those of ordinary skill in the art. As will be readily appreciated by those of ordinary skill in the art, the data dictionary 118 is specific to and requires knowledge of the data source system 102 to fulfill its purpose in mapping and cleaning operations. The data-cleaning module 116 itself, on the other hand, may be agnostic to the data source system 102. In some embodiments, the data-cleaning module 116 is configurable, e.g., via configuration files or user input provided by means of a user interface, to perform selected ones of the mapping and filtering operations described above.

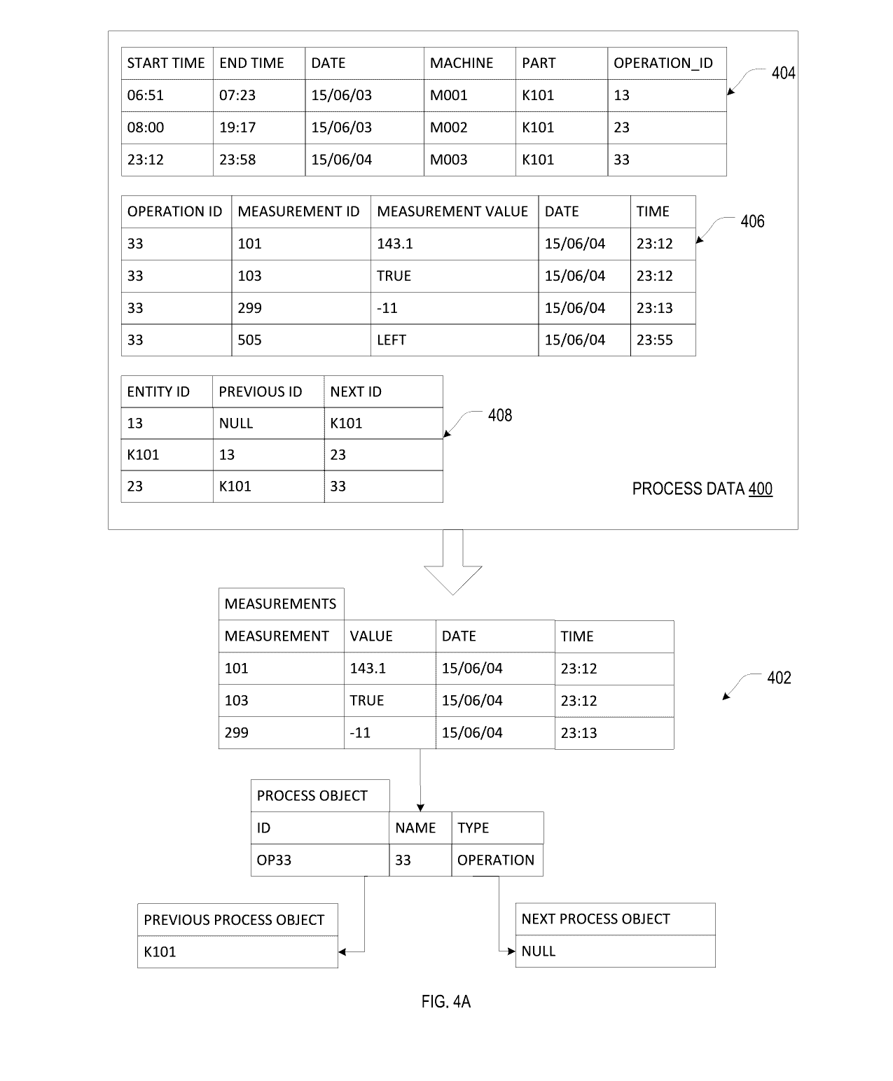

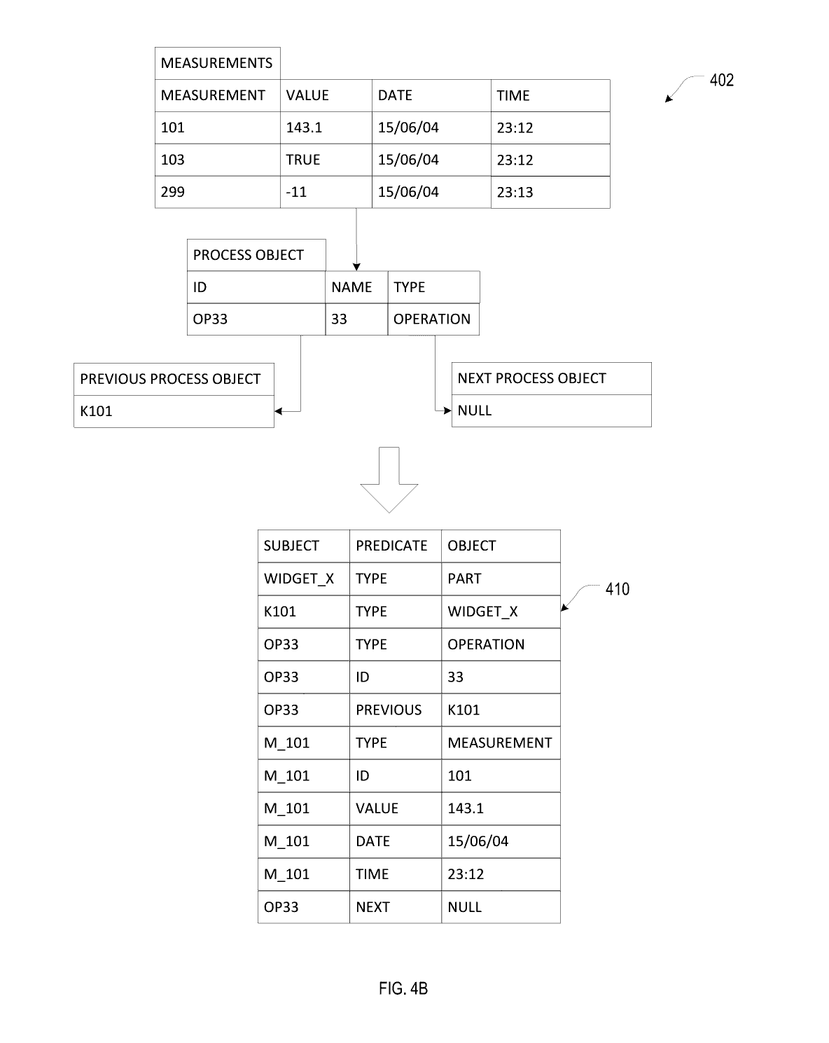

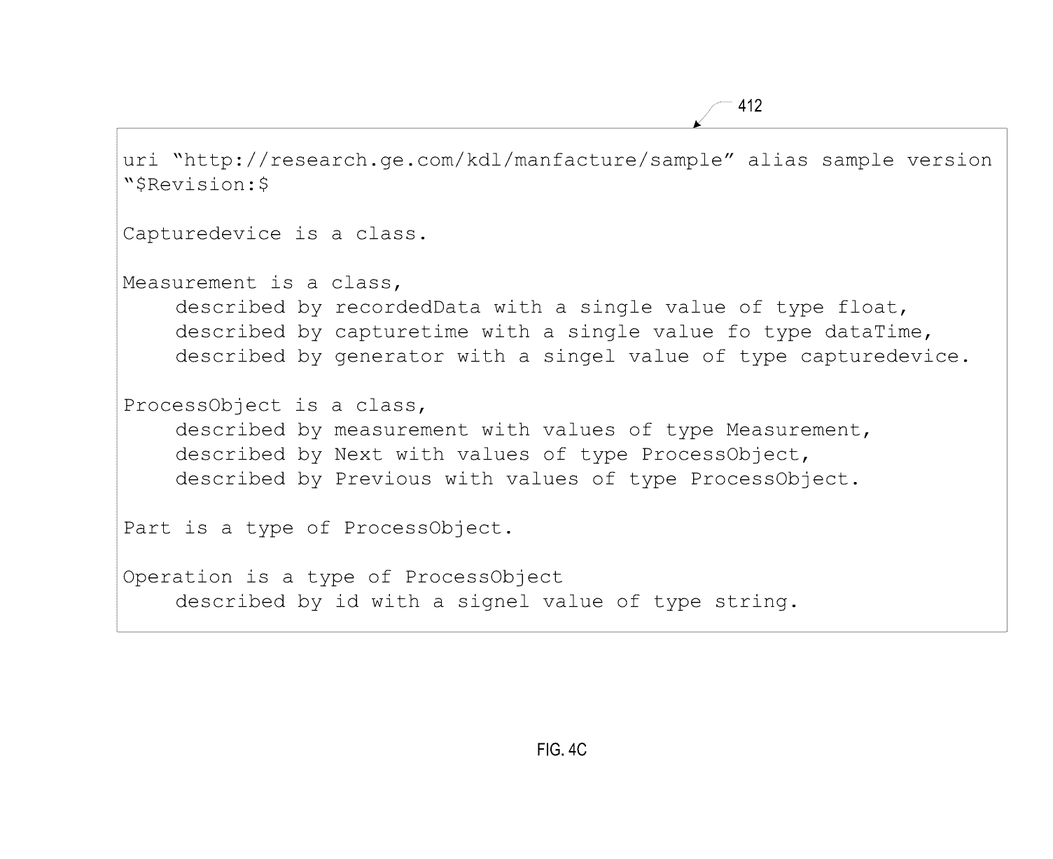

Once the process data has been converted into the intermediate format and, optionally, cleaned, it is handed off to a semantic loader 122, which constitutes or forms part of the second processing tier 120. The semantic loader 122 takes a model and/or templates 124 describing a domain-specific semantic ontology (that is, a formal specification, or “vocabulary,” of concepts used to describe processes in a certain industry, business, or otherwise circumscribed domain) as input, and applies the terms, concepts, and rules of that ontology to the intermediate data representation to generate a semantic representation. The model or templates 124 reflect domain-specific process knowledge, but do not require any knowledge of the data source systems 102 and the particular storage strategy it implements, nor does the semantic loader 122. In the semantic representation, the data may be stored as triples of the form subject-predicate-object, where subjects and objects correspond to entities such as data items or concepts and predicates correspond to relationships between the entities. (See FIG. 4 for a semantic representation of an example process.) The semantic loader may store the semantic data representation in a semantic store 104. Various semantic stores developed for various equally valid semantic ontologies exist and are readily available commercially, and the subject matter disclosed herein can generally be applied to all of them. The semantic loader 122 may be adapted to the specific semantic store 104 used in any given embodiment.

In some example embodiments, as depicted, the semantic representation is extracted from the semantic store 104 into an optional relational (or other type of) database 128. An end-user may access the semantic store 104 and/or, where available, the database 128 to retrieve data for specific queries formulated in meaningful, human-understandable terms. The end-user may also search and/or manipulate the data using a graphic-based format (e.g., depicting the triples stored in the semantic store 104 as etches connecting pairs of nodes in a graph) that is closer in nature to the actual process than the storage-oriented format. Access to the semantic sore 104 and/or database 128 from an external computing system 130, such as a client computer connected to a server hosting the semantic store 104 or database 128 through a network such as the Internet, may be provided, in accordance with some embodiments, via kernel-mediated services 132.

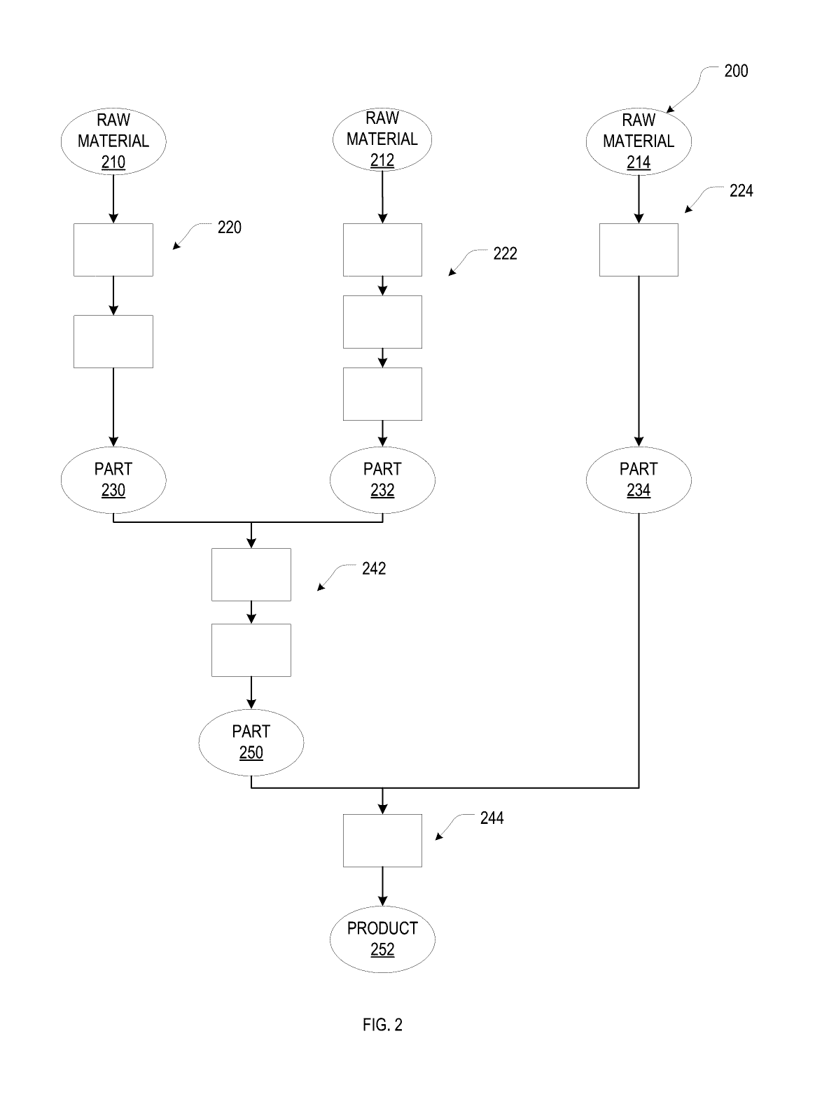

To provide context for a more detailed explanation of the various data representations used and/or generated in accordance with the present disclosure, FIG. 2 conceptually illustrates an example process flow 200. In general, a process may be characterized in terms of its process steps, the materials that flow in and out of the steps, or a combination of both, depending on the type of process and the kind of process data being captured; often, multiple alternative representations are equally valid. In some embodiments, materials are interspersed, or alternate, with the process steps that produce them. For instance, in the process flow 200 of FIG. 2 (where process steps are shown with rectangles and materials with ellipses), three raw materials 210, 212, 214 are processed in separate sequences of process steps 220, 222, 224 to make parts (interpreted as new materials) 230, 232, 234, which are then assembled, in further sequences of process steps 242, 244, into an intermediate part 250 and a final product 252. In some cases, it makes sense to characterize the output of each process step as a new material. In other cases, e.g., where data is captured to characterize a sequence of manipulations performed on a material, but the material itself is not evaluated following each step, there may be no need to reflect the materials in the process flow at every step. Conversely, it may be beneficial to implicitly track the process steps by characterizing the materials at each step. The distinction between process steps and materials may become relevant during the application of semantic terminology to the data. For purposes of generating the intermediate data format, however, process steps and materials can be used interchangeably, and are therefore herein in many places subsumed under the term “process object.”

As further illustrated in FIG. 2, a process may include multiple sub-processes, each comprising a time-ordered sequence of process steps and/or materials, that at least partially overlap in time, but eventually flow into a common process step or material dependent therefrom. For example, in the depicted manufacturing process 200 for making the product 242, the sequences of process steps 220, 222, 224 to manufacture the three constituent parts 220, 222, 224 correspond to three sub-processes that can be performed independently of one another, and thus in parallel. Assembling the three parts 220, 222, 224 into the end product 242 constitutes another sub-process that is dependent upon, and therefore follows in time, the completion of the first three sub-processes 220, 222, 224.

Capturing process data generally involves making one or more observations for each process object, e.g., by recording an identifier for a human or machine operator conducting a particular process step, ascertaining a state of the operator (e.g., in the case of a computer performing a certain step, a hardware state such as processor or memory usage, or a software state such as a fault condition), measuring parameters of a material manipulated in the process (e.g., dimensions, weight, temperature, elastic moduli, color, electrical conductivity, etc. etc.), taking sensor measurements of machine or environmental parameters (e.g., temperature, pressure, vibration frequency, etc.), or storing human input characterizing a process object (e.g., a qualitative or quantitative assessment of product quality, notes regarding special manufacturing conditions, etc.). Depending on what type of data is available and what kind of information technology is used to capture and store the process data, these observations can be linked to the process-object instances to which they pertain in various ways. For example, in an assembly line, each of a series of machines may execute a specific step within a manufacturing process. Assuming a structural representation of the process flow in which machines are associated with process steps is provided as part of the process data, observations stored by a particular machine, such as measurements taken by associated sensors, can then be straightforwardly linked to the process step carried out by that machine. Further, time stamps may be used to distinguish between different instances of the same process step. In other cases, explicit information about the process flow may not be available, and/or some of the machines may be used in multiple process steps. In this case, different instances of a process or sub-process may be distinguished based on the material that is being manipulated, provided a suitable identifier thereof, such as a barcode attached to a product part and scanned in at every process step, is available. The different steps of a process instance pertaining to the same (e.g., bar-coded) material may then be ordered based on their associated time stamps.

As will be readily appreciated by those of ordinary skill in the art, many other methods for linking observations to process objects and at least partially ordering process objects in accordance with the process flow may be available under varying circumstances. For embodiments hereof, it is not crucial how the association between process objects and observations is made and how the ordering of process objects is accomplished, as long as this information can be inferred in one way or another. In particular, it is worth noting that an explicit representation of the process flow in the source data (e.g., in the form of a flow chart), although often beneficial, is not necessarily required to reconstruct the ordering and dependencies within a process or sub-process.

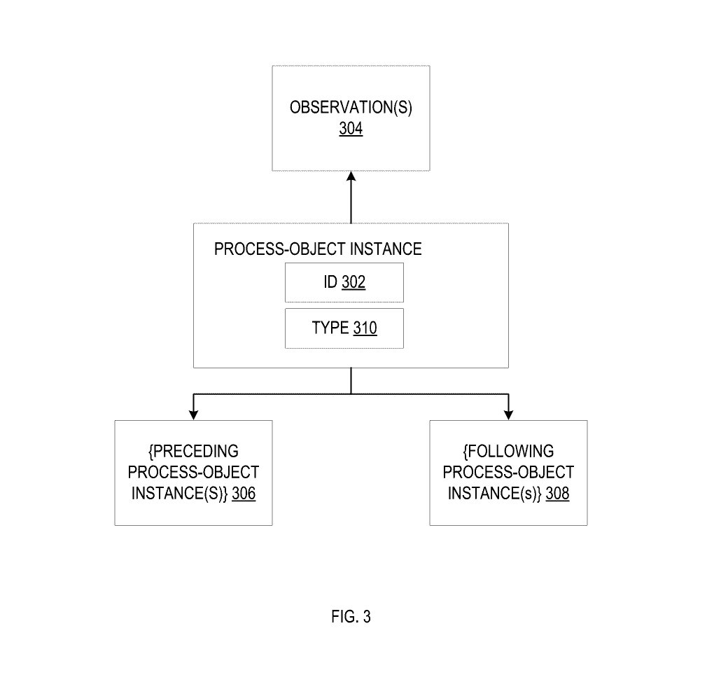

Accordingly, the systems and methods described herein are generally applicable to any kind of process data describing, explicitly or implicitly, an ordered set of process objects described by identifiers (e.g., of materials, machines, etc.) and one or more observations (including, e.g., timing and measurements). That is, a data-source connector module 112 can convert such process data into an intermediate format in which the data pertaining to any particular process-object instance is aggregated into a corresponding data structure. FIG. 3 conceptually illustrates the components of a data structure 300 representing an individual process-object instance in the intermediate format. The data structure 300 includes a unique identifier 302 for the process-object instance, one or more observations 304 made in connection with the process-object instance, a set of identifiers for all (one or more, or zero in the case of the first process object within a process) process-object instances 306 immediately preceding the instance at issue, and a set of identifiers for all (one or more, or zero in the case of the last process object within a process) process-object instances 308 immediately following the instance at issue. As will be readily appreciated by a person of ordinary skill in the art, the specification of preceding and following process-object instances facilitates reconstructing a process flow, or any portion thereof (e.g., defined by start and end times), by following the references to the neighboring process-object instances in either direction (e.g., forward using references to following instances, or backwards using references to preceding instances).

In various embodiments, the process-object identifier 302 is created from the process data itself in a temporally consistent manner, such that re-computation of an identifier for a given process-object instance will always result in the same identifier. This allows converting and loading process data incrementally, e.g., processing different portions at different times, without having to re-process already converted or loaded process-object instances. Instead, data loaded at different times can simply be connected later based on the references for each process-object instance to its neighboring process-object instances. Moreover, a consistently generated, unique identifier is suitable to identify real-world entities in the semantic representation, and allows going back and re-processing data based on, e.g., a refined data dictionary or semantic model. Beneficially, loading process data incrementally avoids the need to wait for a full process run (which may, in many practical circumstances, days, weeks, or even months) to be completed before the data can be processed and analyzed. The data can, instead, be processed in suitable time slices (e.g., at the end of each day or of each manufacturing shift), and its analysis and any conclusions derived therefrom can be updated and refined as more data comes in.

In various example embodiments, the consistent generation of unique identifiers is accomplished by computing a hash from a combination of suitable data items associated with each process-object instance, such as from a time stamp in conjunction with a material bar-code, or from the start and end times associated with a process-step instance (assuming it is extremely unlikely that two instances, even if carried out at roughly the same time, e.g., using different machines, have exactly the same start and end times).

In some embodiments, the data structures 300 for the individual process-object instances further includes an identifier 310 of the process-object type (i.e., the particular process object within a process flow of which each captured process-object instance is an instance), allowing instances of the same process object within a certain process flow to be correlated across multiple process instances. The process-object type may be ascertained with the help of a data dictionary 118. Assume, for example, that a particular manufacturing process is carried out in parallel with multiple lines of manufacturing equipment, or even in multiple factories potentially using different data-storage strategies. Then, absent explicit information in the process data as to which process step is carried out with each piece of equipment, the original process data, without further, does not enable recognizing if two data items acquired at different ones of the manufacturing lines or factories are associated with the same process step. However, it may be possible to find, e.g., naming conventions used for the stored data items which, though possibly entirely different between the different manufacturing sites (e.g., lines or factories), may be mapped onto one another with knowledge of the storage strategies and naming conventions and of the fact that the data pertains to the same process (in different instances of that process). For example, the data may encode the type of machine used for each process step. A data dictionary 118 that translates the label of the machine type as used locally onto a global machine type label then allows process steps to be correlated across the manufacturing sites by virtue of their association with a particular type of machine. In other words, manufacturing-site-specific aliases for the same process object can be removed (even without knowledge of the process flow). In addition, the data dictionary 118 may facilitate mapping, within two different instances of the same process object, the associated variables (capturing observations) to each other. Thus, if, for example, various dimensions of a work piece are measured, the intermediate data collected at different sites carrying out the same process may be cleaned to ensure that the various dimensions are stored in the same order (e.g., length, width, height) for each process-object instance (even if it is, at this stage unknown, which dimension in the real world the data stored at each position within the variable list corresponds to).

Once types have been associated with the process-object instances by reference to the data dictionary 118, the process-object instances may be categorized and binned by type before being handed off to the semantic loader 122. This binning can be beneficial for speeding up the conversion from the intermediate data format into a semantic representation, as the same semantics apply to each process-object instance within a given category. When looking up process-object instances in a data dictionary 118, instances for which no entry can be found may be encountered. These process-object instances may form a separate category for type “unknown.” In some example embodiments, the discovered process-object instances not found in the data dictionary 118 (or clusters of such unknown process-object instances formed based on similarity in the intermediate representation) are reported, e.g., to the user or a software application, for later study and/or classification. Usually, it is beneficial to include all process-object instances, known or unknown, in the data passed on to the semantic loader to avoid distorting the process flow. In some embodiments, all process-object instances are represented in the data sent to the semantic loader, but the observations associated with the process-object instances are filtered (e.g., black-listed or white-listed), e.g., to omit observations associated with unknown process-object types.

In the semantic loader 122, the concepts of a semantic model are applied to the cleaned and conformed data items of the intermediate representation, and the resulting semantic representation is written to a semantic store 104, in accordance with some example embodiments. The semantic model may be provided to the semantic loader 122 in a representation consistent with standard semantic web formats, such as turtle, n-triple, owl, SADL files. In the semantic store, the data may be represented in the form of triples or quads corresponding to a subject, predicate, and object.

FIG. 4A is a diagram illustrating process data 400 for a portion of an example process and an associated process-object instance 402 in the intermediate format, in accordance with an example embodiment. The illustrated process involves three successive operations (an example of process steps) performed on a part (an example of material as used herein) identified as K101 with three respective machines identified as M001, M002, and M003. The process data 400 may be obtained, e.g., in response to a query, from one or more data source systems 102, such as, e.g., memory associated with the machines M001, M002, and M003. In the example shown, the process data 400 includes an operations log 404, measurement data 406, and structural data 408. Each entry of the operations log 404 identifies one of the machines, the operation carried out by the machine, and the part on which the operation was performed, and further includes the date, start time, and end time associated with the operation. The measurement data 406 includes, for each of a number of identified measurements, the operation with which the measurement is associated, the measured value, and the date and time of the measurement (which generally falls between the start and end times of the associated operation). The structural data 408 shows how the process objects (such as part and operations) are linked, allowing the process flow to be constructed. Using the methods described herein, the process data 400 can be reorganized into an intermediate representation of individual process-object instances; FIG. 4A shows the process-object instance 402 for operation 33.

FIG. 4B is a diagram illustrating an example semantic representation 410 corresponding to the process-object instance 402, in accordance with an example embodiment. In the semantic representation 410, the data is stored in triples of the form subject-predicate-object. For example, attributes of the process-object instances (e.g., operation “OP33” or part “K101”) may be stored using the name or identifier of the specific process-object instance as the subject, the type of attribute as the predicate and the attribute value as the object. Similarly, attributes of measurements (e.g., measurement “M101”) may be stored using an identifier of the measurement (such as a combination of “M” and the identifier of the specific measurement) as subject, the type of attribute as predicate, and the attribute value as object. To reflect the structure of the process, the predicates “previous” or “next” may be used, with the pair of directly connected process-object instances being stored as the subject and object of the triple. Further, concepts not directly reflected in the original process data 400, but supplied based on domain knowledge, may be linked to further define attributes of process-object instances by using them as subjects in additional triples. For example, for the process-object instance “K101” of type “WIDGET X,” an additional triple may specify that “WIDGET X” itself is of type “PART.”

FIG. 4C is a diagram illustrating an example semantic model 412 expressed in SADL, in accordance with an example embodiment. Such a model 412 may be provided as input to the semantic loader to 122 to convert the intermediate representation of process-object instances (e.g., process-object instance 402) into the semantic representation 410.

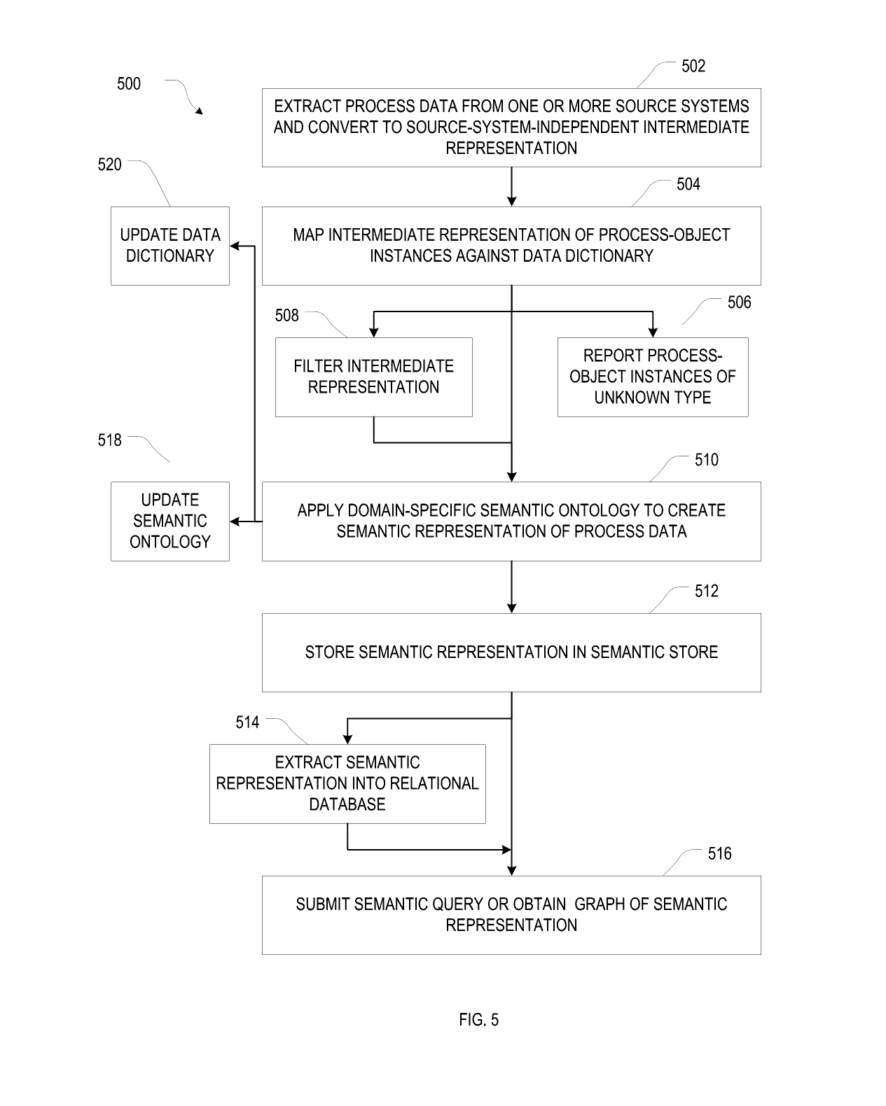

FIG. 5 is a flow chart illustrating an example method 500 for ingesting process data from one or more data source systems into a semantic store, where the data may be accessed by a user. The method involves, at operation 502, extracting process data from one or more data source systems and converting the data to a source-system-independent representation. The intermediate representation may then, optionally, be further processed by comparing the data associated with the process-object instances with a data dictionary to find mappings, e.g., to identify types of process objects and/or of their associated variables (operation 504). Process-object instances and/or variables that cannot be found in the data dictionary may be reported for subsequent analysis (operation 506). The data in the intermediate representation may, additionally, be filtered (operation 508), as explained above.

After conversion and cleaning (mapping and/or filtering) of the data, at operation 510, a domain-specific semantic ontology is applied to the intermediate representation to create a semantic representation of the process data. This semantic representation may be stored, e.g., in the form of semantic triples, in a semantic store (operation 512). Optionally, the semantic triples may further be extracted from the semantic store for storage in a relational database (operation 514). A user may access the semantic representation, e.g., by submitting a specific semantic query, in response to which a specific subset of the data relevant to the query may be returned, or to obtain a graphic depiction of the semantic representation (operation 516). In some cases, the semantic representation serves as a starting point for updating the semantic ontology (operation 518) and/or the data dictionary (operation (520), e.g., based on further human input.

Accordingly, the systems and methods described herein facilitate the extraction of process data from the storage-oriented format of the data source system(s) into a format that allows the use, manipulation, and exploration of the data using domain terms and known associations specific to the domain. Being backed by semantic ontologies, the graph-based format may make associations in the process objects explicit where, before, they may have been apparent only to one knowledgeable of both the process and the data storage system. Thus, users not skilled in the details of the original process-data storage system, but skilled in the domain of interest, are able to interact with the system. This extends to both the access of data in the semantic store as well as involvement in maintenance tasks, such as updating the data dictionary and model. Though the model update may still be performed with the support of one skilled in semantic technologies, various embodiments hereof provide users skilled in the process domain the ability to determine data-dictionary/semantic-model coverage and to begin to categorize unmapped information.

By providing, with the intermediate data representation, an abstraction layer between the data-source and sematic representations that is not specific to a given data storage system or strategy, various embodiments allow the interaction with the data source systems to be handled via adapters, namely the data-source connector modules 112. As a result, the same, generic data-processing pipeline (up to the different data-source connector modules) can be stood up against, for example, a process database as effectively as against a collection of flat files of measurements whose linkages are described via a flow chart, or any data source system in between (provided a suitable data-source connector module exists). This, in turn, may enable implementing the same system at multiple sites (e.g., multiple factories) without much technical overhead for each implementation.

The processing of data in two stages, where structure is applied as late as possible, separates original storage-tier specifics from the semantic model, allowing information to be placed at the appropriate level. For instance, in accordance with various example embodiments, the data dictionary may be a thin layer that simply makes sense of identifier/description conveniences in the storage tier, while the ontologies can be used to apply rules and relationships that are important at a logical level not seen in the source data. This generally allows the semantic model for a given process to be used at different sites implementing that process, regardless of the information-technology systems used at those sites. Changes to the information-technology systems may be reflected in the choice of data-source connector module and the data dictionary.

Further, the intermediate data representation, by using a flexible mechanism for linking process information (via sets of identifiers for the previous and next process-object instances), generally removes the need for fixed process maps. As data is loaded (from the source systems into the semantic store), the actual, per-instance process is captured. Changes to a process are, thus, intrinsically handled. The inclusion of “unknown” types of process objects allows for the system to capture process information for which there is no data dictionary entry or related concept in the semantic model. The data captured on the process reflects the full process at any given point, with particular resolution given to the portions that can be mapped onto the data dictionary and/or semantic model. This may prevent failures to accurately reflect changes to the actual process as they occur.

In various example embodiments, the inclusion of the unknown type and the possibility of directly exporting a collection of data-derived unmapped process objects provide a convenient way to determine model coverage. Further, the ability to export a list of unmapped instances (possibly grouped by class) as well as the potential connections (derived from those found in the real data) creates a logical place for beginning the decisions on which values should be reflected in the model, allowing incremental model building. Consider, as an extreme example, a situation where a data-source connector module for a certain data source system exists, but where there is no data dictionary. By importing data over a time period during which the full process has run and requesting a report of all unmapped process-objects instances, one may obtain an end-to-end representation of the process showing process objects and candidate connections. This data may serve as a starting point to begin building a data dictionary and/or semantic models, which, in turn, can lower the cost of model development.

Further, in some example embodiments, using consistent identifiers in the system facilitates loading process information for partial processes. In other words, process data can be loaded into the semantic store incrementally, e.g., across time or across some meaningful division in the data, with the full process being assembled eventually as a casual effect of the graph-based nature of the semantic store. The ability to load data incrementally also allows filling in previously unknown information by updating the semantic model and re-running the pipeline over the process-object instances or time period of interest.

### Modules, Components, and Logic

Certain embodiments are described herein as including logic or a number of components, modules, or mechanisms. Modules can constitute either software modules (e.g., code embodied on a non-transitory machine-readable medium) or hardware-implemented modules. A hardware-implemented module is a tangible unit capable of performing certain operations and can be configured or arranged in a certain manner. In example embodiments, one or more computer systems (e.g., a standalone, client, or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within an office environment, or a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs)).

### Electronic Apparatus and System

Example embodiments can be implemented in digital electronic circuitry, in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of description language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

Example Machine Architecture and Machine-Readable Medium

FIG. 6 is a block diagram of a machine in the example form of a computer system 600 within which instructions 624 may be executed to cause the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 can further include a video display 610 (e.g., a liquid crystal display (LCD) or a cathode ray tube (CRT)). The computer system 600 also includes an alpha-numeric input device 612 (e.g., a keyboard or a touch-sensitive display screen), a user interface (UI) navigation (or cursor control) device 614 (e.g., a mouse), a disk drive unit 616, a signal generation device 618 (e.g., a speaker), and a network interface device 620.

The disk drive unit 616 includes a machine-readable medium 622 on which are stored one or more sets of data structures and instructions 624 (e.g., software) embodying or utilized by any one or more of the methodologies or functions described herein. The instructions 624 can also reside, completely or at least partially, within the main memory 604 and/or within the processor 602 during execution thereof by the computer system 600, with the main memory 604 and the processor 602 also constituting machine-readable media 622.

While the machine-readable medium 622 is shown in an example embodiment to be a single medium, the term “machine-readable medium” can include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 624 can be transmitted or received over a communication network 626 using a transmission medium. The instructions 624 can be transmitted using the network interface device 620 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

This written description uses examples to disclose the inventive subject matter, including the best mode, and also to enable any person skilled in the art to practice the inventive subject matter, including making and using any devices or systems and performing any incorporated methods. The patentable scope of the inventive subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
automatically converting process data extracted from one or more data source systems into a data-source-independent intermediate representation, the process data comprising (i) information about a process flow comprising a plurality of process objects and (ii) data associated with instances of the process objects, the intermediate format specifying for each of the process-object instances at least a unique object-instance identifier, a set of observations associated with the process-object instance, and references to other process-object instances that immediately precede or immediately follow the process-object instance in the process flow; and
automatically applying a domain-specific semantic ontology to the intermediate representation to create a semantic representation of the process data.

2. The method of claim 1, further comprising, prior to applying the domain-specific semantic ontology, mapping the data associated with the process-object instances against a data dictionary to identify, for at least some of the process-object instances, associated types of process objects.

3. The method of claim 2, further comprising reporting process-object instances that cannot be mapped to any entry in the data dictionary.

4. The method of claim 2, further comprising retaining process-object instances that cannot be mapped to any entry in the data dictionary in the intermediate and semantic representations.

5. The method of claim 2, further comprising filtering the data in the intermediate representation.

6. The method of claim 2, further comprising updating the data dictionary based on the semantic representation of the data.

7. The method of claim 1, further comprising refining the semantic ontology based in part on the process data.

8. The method of claim 1, wherein a manner of converting the process data extracted from the one or more data source systems is at least partially based, for each of the one or more data source systems, on a storage strategy used in that data source system.

9. The method of claim 1, wherein the unique object identifiers are created from the extracted data in a temporally consistent manner.

10. The method of claim 1, wherein the process data is incrementally converted to the intermediate representation.

11. A system comprising:
a plurality of processor-implemented modules, the modules comprising:
one or more data-source connector modules adapted to one or more respective data storage systems and configured to convert process data extracted from the one or more data storage systems into an intermediate representation, the process data comprising (i) information about a process flow comprising a plurality of process objects and (ii) data associated with instances of the process objects, the intermediate format specifying for each of the process-object instances at least a unique object-instance identifier, a set of observations associated with the process-object instance, and references to other process-object instances that immediately precede or immediately follow the process-object instance in the process flow; and
a semantic loader configured to apply a domain-specific semantic ontology to the intermediate representation to create a semantic representation of the process data.

12. The system of claim 11, wherein the plurality of processor-implemented modules further comprise a data-cleaning module configured to map the data associated with the process-object instances against a data dictionary to identify, for at least some of the process-object instances, associated types of process objects.

13. The system of claim 12, further comprising the data dictionary.

14. The system of claim 11, wherein the one or more data-source connector modules are configurable via configuration files.

15. The system of claim 11, further comprising a semantic store, the semantic loader being adapted to the semantic store and configured to load the semantic representation into the semantic store.

16. The system of claim 11, wherein each of the data-source connector modules is configured to generate the object identifiers in a temporally consistent manner.

17. A non-transitory machine-readable storage medium comprising instructions, which, when implemented by one or more machines, cause the one or more machines to perform operations, the operations comprising:
converting process data extracted from one or more data source systems into a data-source-independent intermediate representation, the process data comprising (i) information about a process flow comprising a plurality of process objects and (ii) data associated with instances of the process objects, the intermediate format specifying for each of the process-object instances at least a unique object-instance identifier, a set of observations associated with the process-object instance, and references to other process-object instances that immediately precede or immediately follow the process-object instance in the process flow; and
applying a domain-specific semantic ontology to the intermediate representation to create a semantic representation of the process data.

18. The machine-readable storage medium of claim 17, wherein the operations further comprise:
prior to applying the domain-specific semantic ontology, mapping the data associated with the process-object instances against a data dictionary to identify, for at least some of the process-object instances, associated types of process objects.

19. The machine-readable storage medium of claim 18, wherein the operations further comprise:
reporting process-object instances that cannot be mapped to any entry in the data dictionary.

20. The machine-readable storage medium of claim 17, wherein the operations for converting the process data into the intermediate representation are adapted to the one or more data source systems.
